(19) United States
(12) Patent Application Publication
(10) Pub. No.: US 2024/0137791 A1
(43) Pub. Date: Apr. 25, 2024

(54) WLAN (WIRELESS LOCAL AREA NETWORK) INTERFERENCE ESTIMATION

(71) Applicant: NXP USA, Inc., Austin, TX (US)

(72) Inventors: Rui Cao, Sunnyvale, CA (US); Rong Zhang, San Jose, CA (US); Yan Zhang, Palo Alto, CA (US); Hongyuan Zhang, Fremont, CA (US)

(21) Appl. No.: 18/492,273

(22) Filed: Oct. 22, 2023

Related U.S. Application Data
(60) Provisional application No. 63/380,723, filed on Oct. 24, 2022.

(51) Int. Cl. H04W 24/08

(52) U.S. Cl. CPC H04W 24/08; H04W 84/12

(57) ABSTRACT

One example discloses a method of interference estimation for communications between WLAN (wireless local area network) devices, including: adding a set of interference estimation attributes to a PPDU; transmitting the PPDU from and receiving the PPDU at a WLAN device; and estimating a set of interference statistics, by the WLAN device, by comparing the set of interference estimation attributes to a corresponding set of predefined attribute values.

### REFERENCE TO PROVISIONAL APPLICATION TO CLAIM PRIORITY

A priority date for this present U.S. patent application has been established by prior U.S. Provisional Patent Application, Ser. No. 63/380,723, entitled “Reliable WiFi communications in the presence of interference”, filed on Oct. 24, 2022, and commonly assigned to NXP USA, Inc.

The present specification relates to systems, methods, apparatuses, devices, articles of manufacture and instructions for WLAN (wireless local area network) interference estimation.

### SUMMARY

According to an example embodiment, a method of interference estimation for communications between WLAN (wireless local area network) devices, comprising: adding a set of interference estimation attributes to a PPDU; transmitting the PPDU from and receiving the PPDU at a WLAN device; and estimating a set of interference statistics, by the WLAN device, by comparing the set of interference estimation attributes to a corresponding set of predefined attribute values.

In another example embodiment, the set of interference estimation attributes includes an interference estimation field (IEF) including a set of interference estimation symbols in the PPDU.

In another example embodiment, the interference estimation symbols are inserted periodically every multiple symbols throughout a data portion of the PPDU.

In another example embodiment, the interference estimation symbols include at least one of a STF (short-training field) or EHT-STF, an EHT-LTF (long-training field) symbol, or a combination of both the STF and the EHT-STF.

In another example embodiment, the interference estimation symbols are inserted in a data portion of the PPDU.

In another example embodiment, the interference estimation symbols are present in a preamble portion of the PPDU.

In another example embodiment, the interference estimation field is added to a long-training field (LTF) in a preamble portion of the PPDU.

In another example embodiment, the interference estimation attributes include interference estimation tones in data symbols of the PPDU.

In another example embodiment, the interference estimation tones are unloaded.

In another example embodiment, the interference estimation tones have predefined values.

In another example embodiment, the interference estimation tones are distributed at multiple frequencies throughout a data portion of the PPDU.

In another example embodiment, the interference estimation tones are evenly distributed at multiple frequencies throughout a data portion of the PPDU.

In another example embodiment, the interference estimation tones are distributed based on a priori knowledge of interference at known frequencies in a data portion of the PPDU.

In another example embodiment, the set of interference estimation attributes includes a set of interference estimation (IE) tones in a set of OFDM tones configured to modulate the PPDU.

In another example embodiment, the IE tones include a new tone added to the set of OFDM tones.

In another example embodiment, the IE tones punctures at least one tone in the set of OFDM tones.

In another example embodiment, the IE tones punctures a pilot tone in the set of OFDM tones.

In another example embodiment, the IE tones punctures at least one tone in the set of OFDM tones modulating either a preamble portion or a data portion of the PPDU.

In another example embodiment, a subset of data tones of the PPDU are defined to be punctured.

In another example embodiment, further comprising, shifting an IE tone in the set of IE tones from one data symbol in the PPDU to another data symbol in the PPDU until the interference statistics are measured over an entire bandwidth of the PPDU.

In another example embodiment, the set of IE tones are a distributed RU tone plan.

In another example embodiment, the IE tones share a same spacing as pilot tones.

In another example embodiment, the set of interference estimation attributes include a set of interference estimation symbols in the PPDU; the interference estimation symbols are inserted in a data portion of the PPDU; and the IE tones are included in a preamble portion of the PPDU.

In another example embodiment, the IE tones are added to a long-training field (LTF) in the preamble portion.

In another example embodiment, the set of interference estimation attributes include a set of null data (NULL) tones in a set of OFDM tones configured to modulate the PPDU.

In another example embodiment, the set of null data tones are defined for each signal bandwidth in the set of OFDM tones.

In another example embodiment, the WLAN device is either an access point (AP) or a non-access point station (non-AP STA).

In another example embodiment, the PPDU only includes the set of interference estimation attributes.

In another example embodiment, the PPDU is an interference training PPDU (ITP) that includes the set of interference estimation attributes.

In another example embodiment, the ITP is periodically transmitted by a transmitter for enabling a receiver to estimate the interference statistics and feedback to the transmitter.

In another example embodiment, further comprising, sending the ITP only when a packet error rate for the communications between WLAN devices exceeds a predetermined level.

In another example embodiment, the PPDU includes a legacy preamble portion, an additional preamble portion, and a data portion; and each of the portions includes at least one of the set of interference estimation attributes.

In another example embodiment, wherein the WLAN device is a first WLAN device; further comprising, sending a request, by a second WLAN device, to transmit the interference statistics estimated by the first WLAN device to the second WLAN device.

In another example embodiment, wherein the WLAN device includes a set of transmit attributes or a set of receive attributes; further comprising, adapting either the set of transmit attributes or the set of receive attributes based on the interference statistics estimated.

According to an example embodiment, a WLAN (wireless local area network) device configured as an access point (AP), comprising: a controller configured define a PPDU having a set of interference estimation attributes; wherein the controller is configured to: receive the PPDU including the set of interference estimation attributes from a non-AP station (STA); and estimate a set of interference statistics by comparing the set of interference estimation attributes to a corresponding set of predefined attribute values.

According to an example embodiment, a WLAN (wireless local area network) device configured as a non-access point (AP) station (STA), comprising: a controller configured to: receive a PPDU including a set of interference estimation attributes from an AP; and estimate a set of interference statistics by comparing the set of interference estimation attributes to a corresponding set of predefined attribute values.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example wireless communications network (WLAN).

FIGS. 2A & 2B represent examples of using an interference estimation field (IEF) as an interference estimation attribute.

FIG. 3 represent an example of using a null data tone as an interference estimation attribute.

FIG. 4 represent an example of using a punctured resource unit (RU) as an interference estimation attribute.

FIGS. 5A & 5B represent examples of using an interference training PPDU (ITP) as an interference estimation attribute.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

IEEE (Institute of Electrical and Electronics Engineers) 802 defines communications standards for various networked devices (e.g., Local Area Networks (LAN), Metropolitan Area Networks (MAN), etc.). IEEE 802.11 further defines communications standards for Wireless Local Area Networks (WLAN). As such, communications on these networks must, by agreement, follow one or more communications protocols (i.e. be standards compliant) so that various network devices can communicate. These protocols are not static and are modified (e.g., different generations) over time, typically to improve communications robustness and increase throughput.

In embodiments of a wireless communication network described below, a wireless communications device such as an access point (AP) of a wireless local area network (WLAN) transmits data streams to one or more client stations (STAs). The AP and STAs communicate using one or more communication protocols. These protocols may include IEEE protocols such as: 802.11b; 802.11g; 802.11a; 802.11n [i.e. HT (High Throughput) with Single-User Multiple-Input Multiple-Output (SU-MIMO)]; 802.11ac [i.e. VHT (Very High Throughput) with downlink Multi-User MIMO (MU-MIMO)]; 802.11ax [i.e. HE (High Efficiency) operating at both 2.4- and 5-GHz bands, including OFDMA (Orthogonal Frequency Division Multiple Access) and MU-MIMO with uplink scheduling]; and 802.11be [i.e. EHT (Extra High Throughput) operating at 2.4 GHz, 5 GHz, and 6 GHz frequency bands and a much wider 320 MHz bandwidth].

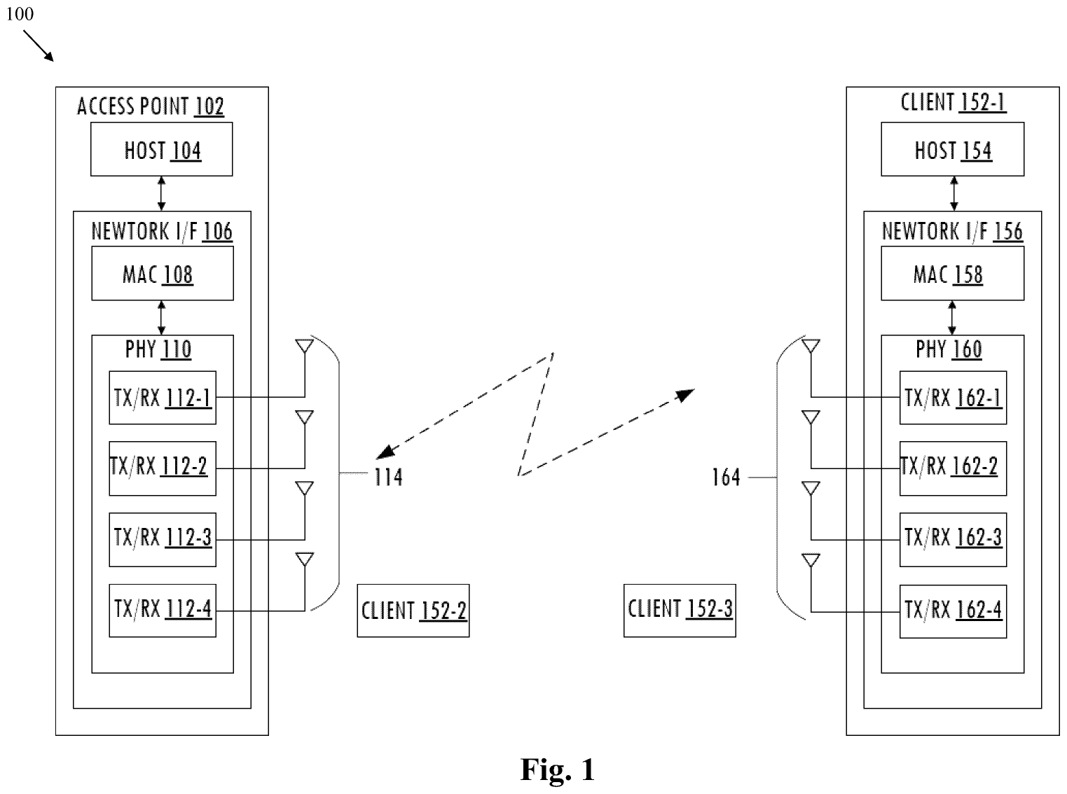

FIG. 1 represents a first example 100 wireless communications network (WLAN) formed by a first set of wireless communications devices (i.e. AP STAs and Client-STAs). The WLAN 100 includes access point station (AP STA) 102 and a set of non-AP stations (non-AP/Client STAs) 152-1, 152-2, and 152-3.

The AP 102 includes host processor 104 (e.g., controller) coupled to network interface 106. Host processor 104 includes a processor configured to execute machine readable instructions stored in a memory device (not shown), e.g., random access memory (RAM), read-only memory (ROM), a flash memory, or other storage device.

Network interface 106 includes medium access control (MAC) processor 108 and physical layer (PHY) processor 110. In some example embodiments the MAC processor 108 operates at the data-link layer of the OSI (Open Systems Interconnection) model and the PHY processor 110 operates at the physical layer of the OSI model.

The PHY processor 110 includes a plurality of transceivers 112-1, 112-2, 112-3, and 112-4, each of which is coupled to a corresponding antenna of antennas 114. These antennas 114 can support MIMO functionality. Each of transceivers 112-1, 112-2, 112-3, and 112-4 includes a transmitter signal path and a receiver signal path, e.g., mixed-signal circuits, analog circuits, and digital signal processing circuits for implementing radio frequency and digital baseband functionality. The PHY processor 110 may also include an amplifier (e.g., low noise amplifier or power amplifier), a data converter, and circuits that perform discrete Fourier transform (DFT), inverse discrete Fourier transform (IDFT), modulation, and demodulation, thereby supporting OFDMA modulation.

The client STAs 152-1, 152-2, and 152-3 each include similar circuits (e.g., host processor 154 (e.g., controller), network interface 156, MAC processor 158, PHY processor 160, transceivers 162-1, 162-2, 162-3, and 162-4, and antennas 164) that provide similar functionality to that of AP 102 but are adapted to client-side specifications.

The MAC 108, 158 and PHY 110, 160 processors within the AP 102 and STA 152-1 exchange PDUs (Protocol Data Units) and SDUs (Service Data Units) in the course of managing the wireless communications traffic. The PHY processor is configured to receive MAC layer SDUs, encapsulate the MAC SDUs into a special PDU called a PPDU (physical layer protocol data units) by adding a preamble.

The preamble (i.e. TXVECTOR, transmission vector) specifies the PPDU's transmission format (i.e. which IEEE protocol (e.g., EHT, HE, etc.) has been used to pack the SDU data payload). The PPDU preambles may include various training fields (e.g., predetermined attributes) that are used by the receiving APs or STAs to perform synchronization, gain control, estimate channel characteristics, and signal equalization. The AP 102 and STA 152-1 then exchange the PPDU formatted wireless communications signals 116.

The wireless communications networks (WLAN) discussed above operate in unlicensed bands (e.g. 2.4 GHz/5 GHz/6 GHz, etc.). Such unlicensed bands hose a variety of wireless devices resulting in inevitable and inherent interference.

802.11 standards are defined to operate in unlicensed channels. For example, in 2.4 GHz, WiFi shares spectrum with Bluetooth (BT), Zigbee, microwave, and surveillance camera, etc. In 5 GHz, WiFi shares spectrum with radar signals, potentially new BT or 15.4 for UWB. Then in 6 GHz/7 GHz, WiFi shares spectrum with existing incumbents, like Fixed services, UWB, LAA, etc.

802.11 defines CSMA(carrier sense multiple access)/CA(collision avoidance) for coexistence among WiFi devices and other technologies to allow distributed medium sharing without collision. For example, carrier sense in primary 20 MHz channels, and energy detection in secondary channels (−72 dBm/20 MHz). However, secondary channels sharing is only based on energy detection, with much worse detection sensitivity than primary channel. Secondary channel access may be allowed in future generations of 802.11, which will cause even more chance of interference.

On the other hand, interference from other technologies, like BT, UWB, LAA/LTE-U, can potentially create strong interference. BT with automatic frequency hopping (AFH) can be transmitted with higher power at adjacent channel. UWB 15.4ab/LAA/LTE-U will share the medium using energy detection. BT commonly implements AFH for better coex with WiFi. Zigbee defines energy detection (e.g. ˜−80 dBm/2.5 MHz). LAA defines energy detection (e.g. ˜−72 dBm/20 MHz).

IEEE 802.11 discusses some channel update techniques. For example, IEEE 802.11ax defines a mid-amble technique for inserting long-training field (LTF) symbols for every “N” non-training PPDU symbols for channel re-estimation to tracking channel doppler. The mid-amble technique may be reused for interference estimation, however, is not optimal for interference statistic estimation.

IEEE 802.11be defines a punctured transmission technique to statically null various resource units (RUs) that incumbents are occupying. However, only contiguous RUs can be punctured and the puncturing granularity is only every 242 RUs, which is also not optimal for interference estimation.

And while LTE/5G CSI-RS defines a Zero Power tone set to allow receivers to estimate interference, this technique requires CSI-RS formatted messages, pre-appending WiFi channel training symbols before PPDU data symbols, using a design similar to the LTE/5G CSI-RS technique, also is not optimal for interference estimation.

Even with these coexistence mechanisms and techniques, the interference statistics can be high resulting in message/PPDU retransmissions. For example, with BT transmitting at high power at adjacent channels of WiFi, the leakage power level can be ˜−80 dBm. Similarly Zigbee/LAA interference power can be ˜−70 dBm/20 MHz.

Thus when interference is present, a receiver's sensitivity is significantly degraded. If the interference is intermittent, then rate adaptation at the transmitter is even more challenging to choose a correct MCS.

Now discussed are PPDU format designs that enable a WLAN receiver to estimate interference statistics and in response adapt their operation to improve packet reception sensitivity. Such estimated interference statistics can then be reported through a link adaptation mechanism WLAN transmitters can also use to enhance rate adaptation.

When a WLAN communications interference signal exists, either an MMSE or an ML detection technique can be used to generate an interference covariance matrix for communications channel interference estimation. Once the interference covariance matrix is calculated, a WLAN device can adapt it's transmission and reception attributes to mitigate any communications channel interference.

Presented below are various interference estimation attributes that can be added to or used to modify a PPDU that would facilitate generation of the interference covariance matrix. In various example embodiments, these attributes may include: new PPDU data formats; new non-UHR preamble portions; new preamble portion (e.g. UHR) and data portion; and using a unique/separate interference training PPDU, that is similar to a sounding NDP, for a WLAN receiver to estimate the channel interference statistics.

Given these attributes WLAN devices can estimate an interference statistic by comparing a set of interference estimation attributes to a corresponding set of predefined attribute values.

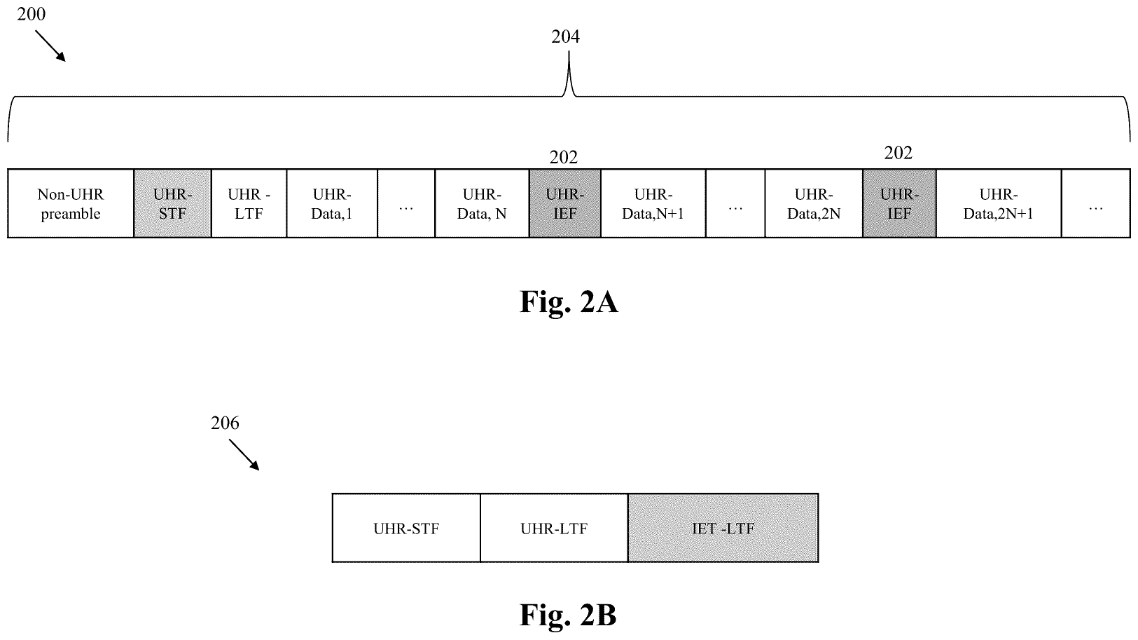

FIGS. 2A & 2B represent examples of using an interference estimation field (IEF) as an interference estimation attribute.

FIG. 2A represents an example 200 of inserting multiple interference estimation fields (IEFs) 202 during a PPDU transmission 204. In various example embodiments, the IEF includes a set of interference estimation symbols.

In some example embodiments, the IEF can be inserted periodically throughout the PPDU transmission. For example, IEF symbols can be inserted every N OFDM symbols for receiver to estimate the interference statistics periodically. The IEF symbols can include unloaded tones that can assist the interference estimation.

In other example embodiments, the IEF symbol can reuse an existing EHT-STF or a new-STF definition. The symbol is loaded only for every M tones, there are M/(M+1) percent of the tones can be used for estimation. More than one STF symbol may be used to improve estimation frequency resolution and accuracy. The symbol may also be used to readjust the gain when interference signal exists. An existing EHT-LTF or a new-LTF may also be inserted after the interference estimation symbols to re-estimate the channel after any gain adjustment.

FIG. 2B represents an example 206 where the IEF symbol reuses an EHT-LTF definition. One or more extra LTFs (IET-LTF) are transmitted so that receiver can estimate the interference statistics. EHT-STF may be pre-appended before the IET LTFs for receiver to readjust the gain when interference signal exists. Regular EHT-LTF may also be included before the IET LTFs for receiver to re-estimate the channel interference statistic. In some example embodiments, the UHR preamble (UHR-STF and UHR-LTF) uses the same format as IET symbol, to enable interference estimation from the preamble.

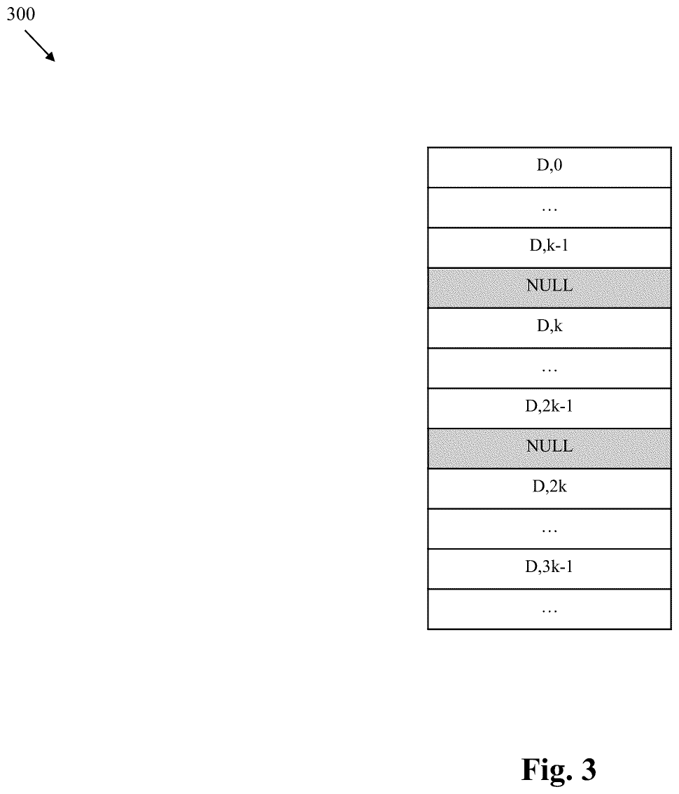

FIG. 3 represent an example 300 of using a null data (NULL) tone as an interference estimation attribute. In this example embodiment, a set of scattered null data tones in a LTF and/or data symbols.

A set of null data tones are defined for each signal bandwidth, e.g. one null tone for each k tones, so that the interference statistics can be estimated for every xMHz, e.g. 1 MHz or 2 MHz or 5 MHz. In this option, New-STF, e.g. UHR-STF are populated every 16 tones for non-TB PPDU, and every 8 tones for TB PPDU. These non-populated tones can be used for interference power estimation. UHR-LTF may leverage the estimate to enhance channel interference statistic estimation.

In some example embodiments, the null data tone plan can reuse a distributed RU tone plan, and the null data tones can be one or more dRU. The transmitter can simply leave null dRUs unscheduled. Define the rest of the allocated dRUs as combined multiple-dRUs for data transmission

In other example embodiments, a set of travelling interference estimation (IE) tones can be used as interference estimation attributes. For example, defining a set of IE tones with certain spacing, e.g. 5 MHz or 10 MHz. These IE tones shift in frequency from data symbol to symbol, so that it can obtain better estimation resolution with more data symbols. In one design, IE tones share the same spacing as pilots, and shift symbol to symbol, so that the IE tones will not overlap with common phase estimation pilots.

In other example embodiments, predefined modulation is loaded to the null tones to be used as interference estimation attributes, similar as pilots in data portion.

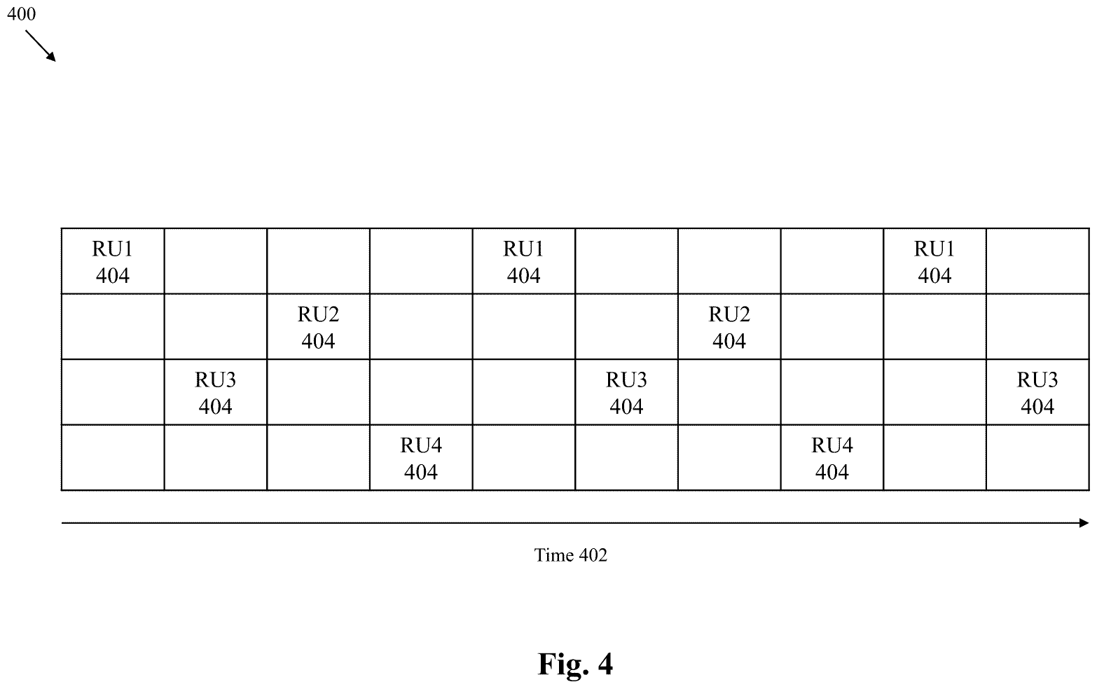

FIG. 4 represent an example 400 of using a punctured resource unit (RU) as an interference estimation attribute. For example, as shown in FIG. 4, labeled RUs (i.e. RU1, RU2, RU3, and RU4) are punctured over time 402 by a traveling interference estimation (IE) tone 404.

The punctured RU location shifts (i.e. travels) from symbol to symbol, within the entire signal BW of the data field. The WLAN receiver can estimate the interference statistics at the particular bandwidths of the punctured RU, and over time cover an entire signal bandwidth in a travelling period. The punctured RU size is determined based on interference signal BW, tolerable interference statistic and transmission efficiency requirement. E.g. 242RU within 80 MHz. The punctured RU can be a contiguous-tone RU or distributed RU.

In other example embodiments, a legacy preamble portion of a PPDU can be used for interference estimation attributes. For example, an L-STF already has null tones every 3 out of 4 tones, which can be used for interference power estimation. The L-LTF may leverage the estimate in L-STF to enhance channel estimation. Scattered null data tones may also be defined within the L-LTF.

In yet other example embodiments, nulled pilots can be used as interference estimation attributes. There are four pilots in each 20 MHz secondary channel. Transmitter may choose not to transmit any signal on pilots for receiver to estimate the interference power on each 20 MHz. In some example embodiments, only 4 pilots in each 20 MHz can be leverage, the estimation resolution is roughly 5 MHz, and it is not suggested for primary 20 MHz.

Punctured tones can also be used as interference estimation attributes. The punctured data tones can be scattered across an entire BW of the PPDU, e.g. puncture tones for every 2 MHz or 5 MHz. Punctured tones are defined for each 20 MHz.

For BW wider than 20 MHz, the punctured tones can be same for all 20 MHz subchannels, or complementary punctured tones can be defined across different 20 MHz, such that receiver can estimate the interference and combine across 20 MHz subchannels to decode the SIG content.

To assist LSIG/RLSIG/U-SIG decoding with nulled and/or punctured tones, some MAC control (e.g. RTS/CTS) is needed to signal PPDU BW and the new PPDU format before PPDU transmission. For fields after U-SIG, U-SIG content will signal the new format or mode with nulled/punctured data tones. Receiver will be able to know the format to either estimate or not.

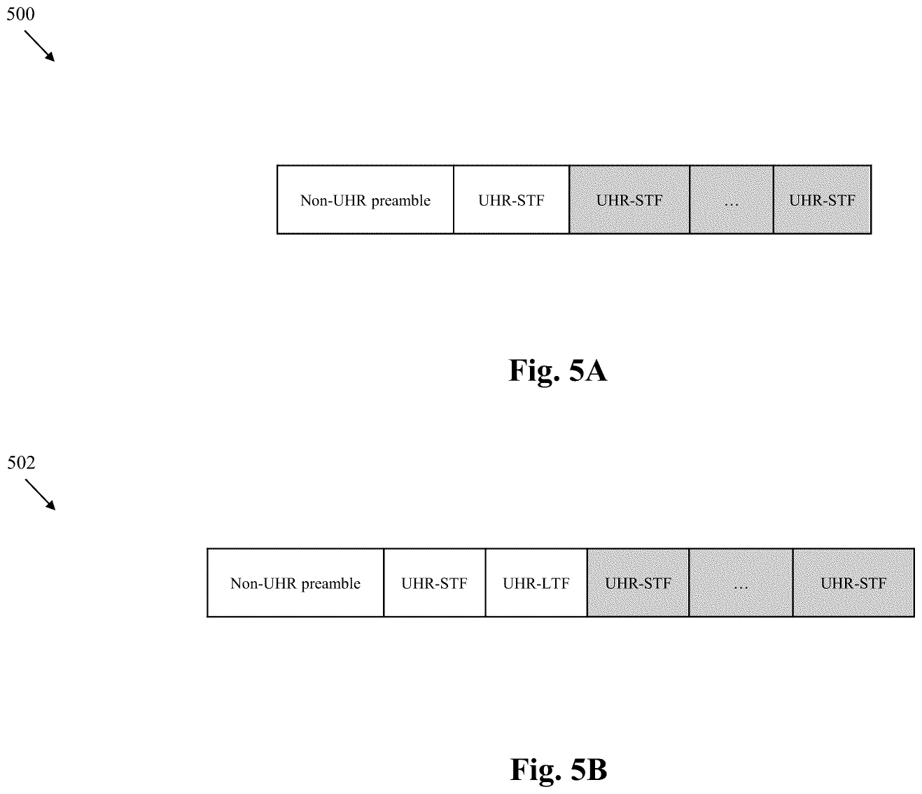

FIGS. 5A & 5B represent examples of using an interference training PPDU (ITP) as an interference estimation attribute. For persistent interference sources, interference can be trained more sparsely by periodically sending the ITP to obtain the interference statistics; or sending the ITP only when a greater packet error rate is observed. The interference training PPDU can be defined in a way similar to a sounding NDP, and sent out periodically for the receiver to estimate the interference statistics and feedback to transmitter.

FIG. 5A represents an example 500 of an interference training PPDU (ITP). The ITP includes interference estimation symbols UHR-STF, like one or more UHR-STF symbols. Similar protocol as sounding can be designed for interference estimation feedback, ITPA>>>ITP>>>feedback. The ITPA frame indicates the following ITP and request for interference estimation feedback.

FIG. 5B represents an example 502 of an interference training PPDU (ITP) appended to a modified sounding NDP (MNDP). The ITP is appended after UHR-LTF, like UHR-STF(s). Protocol can be similar to sounding protocol, NDPA>>>MNDP>>>feedback. Beamformee will feed back interference statistics estimation to beamformer, together with compressed channel state information. One or more bits in NDPA indicate the following new training PPDU format (i.e. MNDP) and request for interference estimation feedback.

In various example embodiments, in response collection of the interference statistics and generation of the interference covariance matrix, one or more WLAN devices may adapt their communications attributes in one or more ways.

For example, interference impact is often asymmetric and dynamic between an AP and various non-AP STAs. Interference is likely more common and has higher power observed by edge STAs in a BSS, but relatively less common and lower power by AP. Each WLAN receiver can experience different interference and interference statistics various from time to time.

WLAN device receiver feedback of the interference attributes through the communications channel to other WLAN devices enables better rate adaptation optimize during times of higher interference. The interference statistics used for feedback may include an existence of an interference signal, the interference signal's frequency and/or power level, and the interference signal's duration and density.

In some example embodiments, the feedback information can be sent in Link adaptation subfields in ACK/BA/MBA frame or separate control frame. A WLAN transmitter after receiving the feedback may adapt in one or more of the following ways.

If the interference is static, strong and dense, the transmitter may choose to statically puncture one RU. If the interference is strong but sparse, the transmitter may choose to use regular PPDU, and not to drop rate too quickly. If the interference is random and dense, the transmitter may choose to send IEF more frequently. The WLAN transmitter can also decide to notch those subchannel(s) that have strong interference power, or to power boost PPDUs transmitted through such subchannel(s).

Various instructions and/or operational steps discussed in the above Figures can be executed in any order, unless a specific order is explicitly stated. Also, those skilled in the art will recognize that while some example sets of instructions/steps have been discussed, the material in this specification can be combined in a variety of ways to yield other examples as well, and are to be understood within a context provided by this detailed description.

In some example embodiments these instructions/steps are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A method of interference estimation for communications between WLAN (wireless local area network) devices, comprising:
adding a set of interference estimation attributes to a PPDU;
transmitting the PPDU from and receiving the PPDU at a WLAN device; and
estimating a set of interference statistics, by the WLAN device, by comparing the set of interference estimation attributes to a corresponding set of predefined attribute values.

2. The method of claim 1:
wherein the set of interference estimation attributes includes an interference estimation field (IEF) including a set of interference estimation symbols in the PPDU.

3. The method of claim 2:
wherein the interference estimation symbols are inserted periodically every multiple symbols throughout a data portion of the PPDU.

4. The method of claim 2:
wherein the interference estimation symbols include at least one of a STF (short-training field) or EHT-STF, an EHT-LTF (long-training field) symbol, or a combination of both the STF and the EHT-STF.

5. The method of claim 2:
wherein the interference estimation symbols are inserted in a data portion of the PPDU.

6. The method of claim 2:
wherein the interference estimation symbols are present in a preamble portion of the PPDU.

7. The method of claim 2:
wherein the interference estimation field is added to a long-training field (LTF) in a preamble portion of the PPDU.

8. The method of claim 1:
wherein the interference estimation attributes include interference estimation tones in data symbols of the PPDU.

9. The method of claim 8:
wherein the interference estimation tones are unloaded.

10. The method of claim 8:
wherein the interference estimation tones have predefined values.

11. The method of claim 8:
wherein the interference estimation tones are distributed at multiple frequencies throughout a data portion of the PPDU.

12. The method of claim 8:
wherein the interference estimation tones are evenly distributed at multiple frequencies throughout a data portion of the PPDU.

13. The method of claim 8:
wherein the interference estimation tones are distributed based on a priori knowledge of interference at known frequencies in a data portion of the PPDU.

14. The method of claim 1:
wherein the set of interference estimation attributes includes a set of interference estimation (IE) tones in a set of OFDM tones configured to modulate the PPDU.

15. The method of claim 14:
wherein the IE tones include a new tone added to the set of OFDM tones.

16. The method of claim 14:
wherein the IE tones punctures at least one tone in the set of OFDM tones.

17. The method of claim 14:
wherein the IE tones punctures a pilot tone in the set of OFDM tones.

18. The method of claim 14:
wherein the IE tones punctures at least one tone in the set of OFDM tones modulating either a preamble portion or a data portion of the PPDU.

19. The method of claim 14:
wherein a subset of data tones of the PPDU are defined to be punctured.

20. The method of claim 14:
further comprising, shifting an IE tone in the set of IE tones from one data symbol in the PPDU to another data symbol in the PPDU until the interference statistics are measured over an entire bandwidth of the PPDU.

21. The method of claim 14:
wherein the set of IE tones are a distributed RU tone plan.

22. The method of claim 14:
wherein the IE tones share a same spacing as pilot tones.

23. The method of claim 14:
wherein the set of interference estimation attributes include a set of interference estimation symbols in the PPDU;
wherein the interference estimation symbols are inserted in a data portion of the PPDU; and
wherein the IE tones are included in a preamble portion of the PPDU.

24. The method of claim 23:
wherein the IE tones are added to a long-training field (LTF) in the preamble portion.

25. The method of claim 1:
wherein the set of interference estimation attributes include a set of null data (NULL) tones in a set of OFDM tones configured to modulate the PPDU.

26. The method of claim 25:
wherein the set of null data tones are defined for each signal bandwidth in the set of OFDM tones.

27. The method of claim 1:
wherein the WLAN device is either an access point (AP) or a non-access point station (non-AP STA).

28. The method of claim 1:
wherein the PPDU only includes the set of interference estimation attributes.

29. The method of claim 1:
wherein the PPDU is an interference training PPDU (ITP) that includes the set of interference estimation attributes.

30. The method of claim 29:
wherein the ITP is periodically transmitted by a transmitter for enabling a receiver to estimate the interference statistics and feedback to the transmitter.

31. The method of claim 29:
further comprising, sending the ITP only when a packet error rate for the communications between WLAN devices exceeds a predetermined level.

32. The method of claim 1:
wherein the PPDU includes a legacy preamble portion, an additional preamble portion, and a data portion; and
wherein each of the portions includes at least one of the set of interference estimation attributes.

33. The method of claim 1:
wherein the WLAN device is a first WLAN device;
further comprising, sending a request, by a second WLAN device, to transmit the interference statistics estimated by the first WLAN device to the second WLAN device.

34. The method of claim 1:
wherein the WLAN device includes a set of transmit attributes or a set of receive attributes;
further comprising, adapting either the set of transmit attributes or the set of receive attributes based on the interference statistics estimated.

35. A WLAN (wireless local area network) device configured as an access point (AP), comprising:
a controller configured define a PPDU having a set of interference estimation attributes;
wherein the controller is configured to:
receive the PPDU including the set of interference estimation attributes from a non-AP station (STA); and
estimate a set of interference statistics by comparing the set of interference estimation attributes to a corresponding set of predefined attribute values.

36. A WLAN (wireless local area network) device configured as a non-access point (AP) station (STA), comprising:
a controller configured to:
receive a PPDU including a set of interference estimation attributes from an AP; and
estimate a set of interference statistics by comparing the set of interference estimation attributes to a corresponding set of predefined attribute values.
